(19) United States
(12) Patent Application Publication
(10) Pub. No.: US 2025/0205986 A1
(43) Pub. Date: Jun. 26, 2025

(54) Crafting Pad

(71) Applicant: Cricut, Inc., South Jordan, UT (US)

(72) Inventors: Yung Tseng Chen, San Francisco, CA (US); Thomas Crisp, Cottonwood Heights, UT (US); Francois Laine, Walnut Creek, CA (US); William H. Smith, San Anselmo, CA (US); Kenneth Sweet, Oakland, CA (US)

(73) Assignee: Cricut, Inc., South Jordan, UT (US)

(21) Appl. No.: 18/848,236

(22) PCT Filed: Mar. 6, 2023
(86) PCT No.: PCT/US2023/063786

§ 371 Date: Sep. 18, 2024

Related U.S. Application Data
(60) Provisional application No. 63/316,886, filed on Mar. 4, 2022.

(51) Int. Cl. B30B 15/06; B32B 5/02; B32B 15/14; B32B 15/20; B32B 25/20; B41F 16/00

(52) U.S. Cl. CPC B30B 15/061; B32B 5/024; B32B 15/14; B32B 15/20; B32B 25/20; B41F 16/0093; B32B 2262/0276; B32B 2307/302; B32B 2307/744

(57) ABSTRACT

A crafting pad may include an enclosure portion and a multi-layered composite portion. The enclosure portion defines an enclosure pocket and the multi-layered composite portion is retained in the enclosure pocket, according to various embodiments. The crafting pad is generally configured to facilitate heat transfer from a heat press to a workpiece operably engaged against the crafting pad.

### CROSS-REFERENCE TO RELATED APPLICATIONS

This application claims the benefit of, and priority to, United States Provisional Patent Application No. 63/316,886 filed on Mar. 4, 2022, which is incorporated herein by reference.

### TECHNICAL FIELD

This disclosure relates to crafting pads, and more particularly to a crafting pad structure that facilitates heat transfer from a heat press to a workpiece engaged against the crafting pad.

### BACKGROUND

Heat presses, in the crafting industry, are machines that are designed to transfer heat to a workpiece to implement a heat-activated design onto or into the workpiece. In the crafting industry, there are many different heat-activated implements, materials, and/or designs, and there are many different types of workpiece material that can be configured to receive the heat-activated implements. For example, heat-activated implements, such as heat-transfer vinyl and/or sublimation inks, can be produced (e.g., cut, printed, drawn, etc.) and transferred (using a heat press) to a variety of materials, such as textiles, fabrics, wood materials, plastics, ceramics, etc. However, various challenges arise when preparing workpiece materials to receive the heat-activated design implements. Said differently, the workpiece materials need to be properly positioned relative to the heat press, and the heat-activated design implements themselves need to be properly positioned and oriented relative to the workpiece material. Further, workpiece materials may lack sufficient support to receive desired design elements, and/or the act of heating the workpiece materials using a heat press may damage to the tabletop or other work surface upon which the heat transfer process is being performed.

### SUMMARY

The subject matter of the present disclosure has been developed in response to the present state of the art, and in particular, in response to the problems and needs in the art that have not yet been fully solved by currently available heat transfer systems and associated accessories. Accordingly, the present disclosure has been developed to provide a crafting pad that overcomes many or all of the above-discussed shortcomings in the art, in accordance with various embodiments.

Disclosed herein, according to various embodiments, is a crafting pad. The crafting pad may include an enclosure portion and a multi-layered composite portion. The enclosure portion defines an enclosure pocket and the multi-layered composite portion is retained in the enclosure pocket, according to various embodiments. The crafting pad is generally configured to facilitate heat transfer from a heat press to a workpiece operably engaged against the crafting pad.

In various embodiments, the crafting pad includes an upper surface, a lower surface opposite the upper surface, and a sidewall section that defines a perimeter of the crafting pad. In various embodiments, an outwardly facing surface of at least a portion of the sidewall section has convex curvature, as defined along a direction extending from the upper surface toward the lower surface. The sidewall section having the convex curvature may extend circumferentially around the entire perimeter of the crafting pad. The convex curvature may extend from the upper surface to a flange of the sidewall section of the crafting pad. The flange may be an outwardly extending lip of the sidewall section.

In various embodiments, the enclosure portion comprises a first enclosure layer and a second enclosure layer. The upper surface may be a surface of the first enclosure layer and the lower surface may be a surface of the second enclosure layer. The first enclosure layer and the second enclosure layer may be coupled together at the flange. In various embodiments, the outwardly facing surface of the sidewall section is a surface of the first enclosure layer, such that the first enclosure layer forms the upper surface and extends to form the outwardly facing surface of the sidewall section of the crafting pad. In various embodiments, in response to the crafting pad being supported by a flat planar surface, such as a platen of a heat press and/or a tabletop, the flange extends in a direction that is substantially parallel to the lower surface and substantially parallel to the flat planar surface. In various embodiments, the flange forms the outward most footprint of the crafting pad.

In various embodiments, the crafting pad further includes a foot layer coupled to the lower surface. The foot layer may be configured to facilitate frictional engagement with at least one of a platen of a heat press and a tabletop. In various embodiments, the foot layer comprises at least one of a silicone material and a rubber material. In various embodiments, the crafting pad further includes a skirt portion extending from the enclosure portion, the skirt portion being configured to reversibly extend around and at least partially envelope a border edge of a platen of a heat press to facilitate retention of the crafting pad against the platen.

In various embodiments, the multi-layered composite portion comprises at least one fill layer and a heat-reflective layer. The multi-layered composite portion is entirely retained within the enclosure pocket, according to various embodiments. In various embodiments, the at least one fill layer includes a first fill layer and a second fill layer. In various embodiments, the heat-reflective layer is disposed between the first fill layer and the second fill layer. The first fill layer may include a fibrous material, the heat-reflective layer may include a metallic foil material, and the second fill layer may include a foam material. In various embodiments, the first fill layer comprises at least one of a polyester felt material and a polyester batting material, the heat-reflective layer comprises aluminum, and the second fill layer comprises a fibrous material. In various embodiments, the crafting pad further includes a stiffening panel disposed within the enclosure pocket, the stiffening panel configured to impart additional rigidity to the crafting pad.

Also disclosed herein, according to various embodiments, is a crafting pad that includes an enclosure portion and a multi-layered composite portion. The enclosure portion may define an enclosure pocket, with the enclosure portion also defining an upper surface of the crafting pad, a lower surface of the crafting pad opposite the upper surface, and a sidewall section of the crafting pad that defines a perimeter of the crafting pad. The multi-layered composite portion may be retained in the enclosure pocket, with the multi-layered composite portion comprising a first fill layer and a heat-reflective layer. In such embodiments, an outwardly facing surface of a sidewall of at least the first fill layer of the multi-layered composite is convexly curved so as to correspondingly impart a convex curvature to the sidewall section of the enclosure portion.

In various embodiments, the crafting pad is configured to facilitate heat transfer from a heat press to a workpiece operably engaged against the crafting pad. In various embodiments, the multi-layered composite further comprises a second fill layer, wherein an outwardly facing surface of a sidewall of the second fill layer is also convexly curved so as to also contribute to the convex curvature of the sidewall section.

The forgoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

In order that the advantages of the disclosure will be readily understood, a more particular description of the disclosure briefly described above will be rendered by reference to specific embodiments that are illustrated in the appended drawings. Thus, although the subject matter of the present disclosure is particularly pointed out and distinctly claimed in the concluding portion of the specification, a more complete understanding of the present disclosure, may best be obtained by referring to the detailed description and claims when considered in connection with the drawing figures. Understanding that these drawings depict only typical embodiments of the disclosure and are not therefore to be considered to be limiting of its scope, the subject matter of the present application will be described and explained with additional specificity and detail through the use of the accompanying drawings, in which:

FIG. 1 is a top perspective view of a crafting pad, in accordance with various embodiments;

FIG. 2 is a bottom perspective view of a crafting pad, in accordance with various embodiments;

FIG. 3 is a front elevation view of a crafting pad, in accordance with various embodiments;

FIG. 4 is a cross-sectional view of a crafting pad, in accordance with various embodiments;

FIG. 5 is an exploded view of a crafting pad, in accordance with various embodiments;

FIG. 6 is a cross-sectional view of a crafting pad, in accordance with various embodiments;

FIG. 7 is a perspective view of a heat press apparatus, in accordance with various embodiments;

FIG. 8 is a perspective view of a crafting pad disposed on a platen of a heat press apparatus, in accordance with various embodiments; and

FIG. 9 is a perspective view of a crafting pad attached to a platen of a heat press apparatus, in accordance with various embodiments.

### DETAILED DESCRIPTION

The detailed description of exemplary embodiments herein refers to the accompanying drawings, which show exemplary embodiments by way of illustration. While these exemplary embodiments are described in sufficient detail to enable those skilled in the art to practice the disclosure, other embodiments may be realized and logical changes and adaptations in design and construction may be made in accordance with this disclosure without departing from the spirit and scope of the disclosure. Thus, the detailed description herein is presented for purposes of illustration only and not of limitation.

Disclosed herein, according to various embodiments, is a crafting pad, which may be referred to as a heat press pad, a crafting mat, a crafting pad, a crafting cushion or the like. As will be described in greater detail in the following disclosure, the crafting pad may be utilized in the process of preparing, decorating, making, or otherwise generally performing crafting-type work on a workpiece (e.g., a crafted object). For example, the crafting pad may generally be configured to support a workpiece and/or a heat-activated design implement during a heat press procedure for transferring a design of the heat-activated design implement to the workpiece. Said differently, the crafting pad may be generally configured to facilitate transfer of heat to a workpiece that is operably engaged against the crafting pad.

The crafting pad may include a plurality of layers. As described in greater detail below, the plurality of layers may include one or more surface cosmetic layers, one or more “enclosure” layers, and one or more interior layers. The enclosure layers, such as an upper enclosure layer and a lower enclosure layer, may respectively define opposing surfaces, and one or more surface layers, coatings, or coverings may be attached to the enclosure layers, as described in greater detail below. Generally, the enclosure layer(s) define an internal volume, referred to herein as an enclosure pocket, within which the one or more interior body layers are disposed. The interior body layers are generally referred to herein as the multi-layered composite portion of the crafting pad. Additional details pertaining to the structure/layup of the crafting pad are provided below.

The crafting pad may also comprise a securement structure, such as a skirt, which may include a layer, feature, and/or a component or the like, that is configured to facilitate detachable (e.g., reversible, temporary) securement of the crafting pad. That is, the securement structure of the crafting pad may be configured to limit and/or inhibit movement of the crafting pad relative to a machine used for performing work on the workpiece. For example, the securement structure of the crafting pad may be configured to detachably secure the crafting pad to a platen of a heat press device, as described in greater detail below. Further, the securement structure of the crafting pad may be configured to detachably secure the crafting pad to a tabletop or other surface where crafting work is to be performed on the workpiece.

The crafting pad disclosed herein may be configured to provide support to a workpiece during a crafting operation. In various embodiments, the crafting pad is resiliently flexible. Accordingly, the crafting pad may comprise textile, foam, silicone, and/or rubber materials, and thus may be substantially flexible and or may be reversibly compressible. For example, the crafting pad may provide cushioning so that workpieces with certain protruding and/or rigid portions, such as buttons on a shirt, can be pressed downward into the pad when a heat plate, such as an upper platen of a heat press, is pressed against the workpiece. In this way, the cushioned pad allows for increased contact area between the upper platen and the workpiece, even with protruding, rigid portions such as buttons, zippers, tags, thick seams, and the like.

In various embodiments, the crafting pad may be configured to protect a surface of a support member such as, for example, a tabletop or a lower platen of a heat press, during a crafting step or during a crafting procedure. In various embodiments, the crafting pad may permit moisture contained in the workpiece to pass through some of the layers of the assembly, but not all of the layers of the assembly. In various embodiments, various layers of the crafting pad may allow heat from a heating device (e.g., a heat press) to pass partially therethrough before being reflected back toward the workpiece. Further, the multiple layers of the crafting pad may be configured to be compressed or compliant when pressure is applied from, for example, one or more of a force imparted by a user or the weight of the heating device during a crafting step.

While numerous details and examples are included herein pertaining to using the crafting pad in association with a two-platen heat press, the crafting pad may be utilized in conjunction with other types of heat presses, and/or may be generally utilized in conjunction with other types of crafting machines and/or for other crafting purposes. Accordingly, the scope of the present disclosure is not necessarily limited to mats/pads for heat presses, as other uses and/or applications for the crafting pad are contemplated.

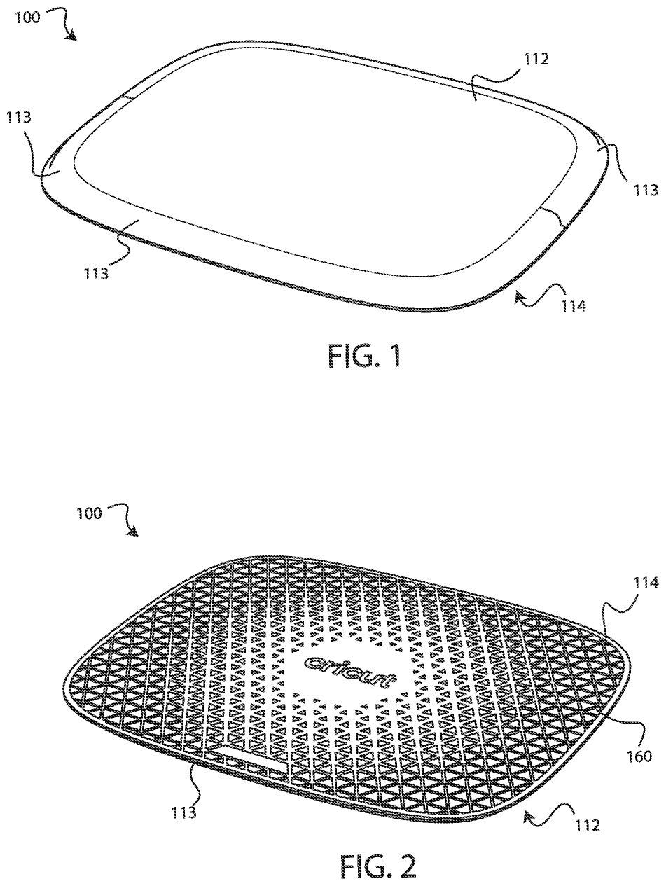

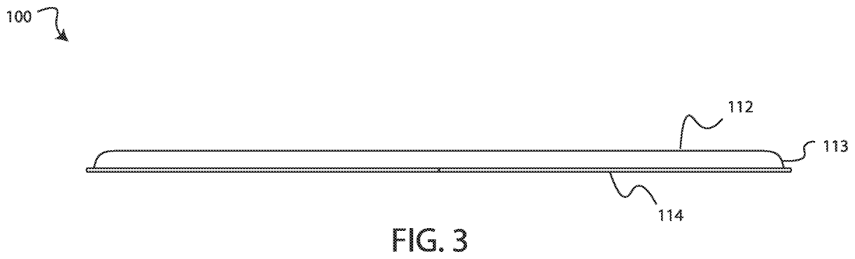

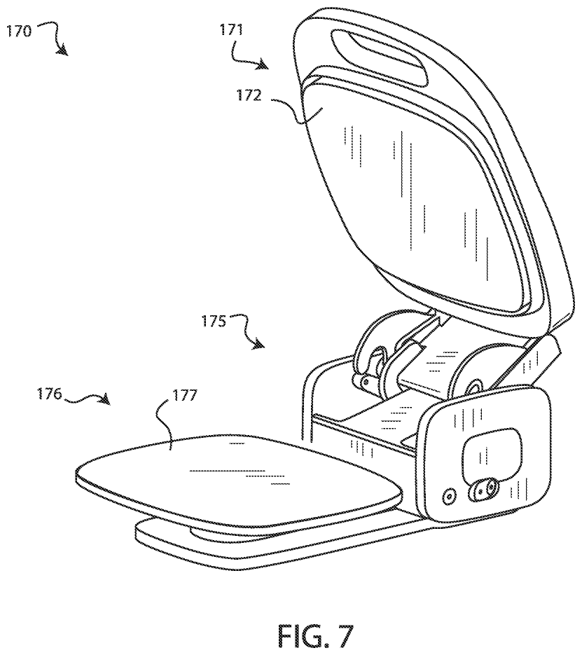

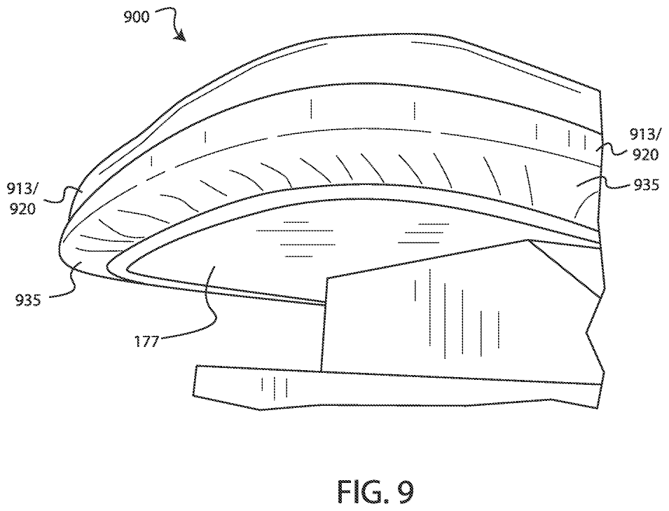

The remainder of the disclosure provides various details with reference to the accompanying figures. FIGS. 1-6, and the associated paragraphs herein, provide details relating to a structure of a crafting pad, according to various embodiments. FIG. 7, and the associated paragraphs herein, provide details pertaining to a heat press apparatus, according to various embodiments. FIGS. 9 and 10, and the associated paragraphs herein, provide details pertaining to method(s) of implementing and/or using a crafting pad with a heat press apparatus, according to various embodiments.

In various embodiments, and with reference to FIGS. 1, 2, and 3, the crafting pad 100 comprises an upper surface 112, a lower surface 114 opposite the upper surface 112, and a sidewall section 113 that defines a perimeter of the crafting pad 100. Said differently, the sidewall section 113 of the crafting pad 100 is the border or edge portion of the crafting pad 100 that connects the upper surface 112 to the lower surface 114. In various embodiments, both the upper surface 112 and the lower surface 114 are substantially planar (macro planar). While the crafting pad 100 may be flexible or resiliently flexible and thus may be rolled, bent, or otherwise manipulated by a user while moving and/or storing the crafting pad 100, the crafting pad 100, when disposed on a planar surface such as a table or a platen of heat press, may generally have a corresponding planar form factor. In various embodiments, the lower surface 114 of the crafting pad 100 may have a foot layer 160 disposed thereon, and the foot layer 160 may have a desired cosmetic and/or aesthetic appearance and may also facilitate frictional engagement of the crafting pad 100 with a working surface, such as a tabletop or a platen of a heat press, as described in greater detail below.

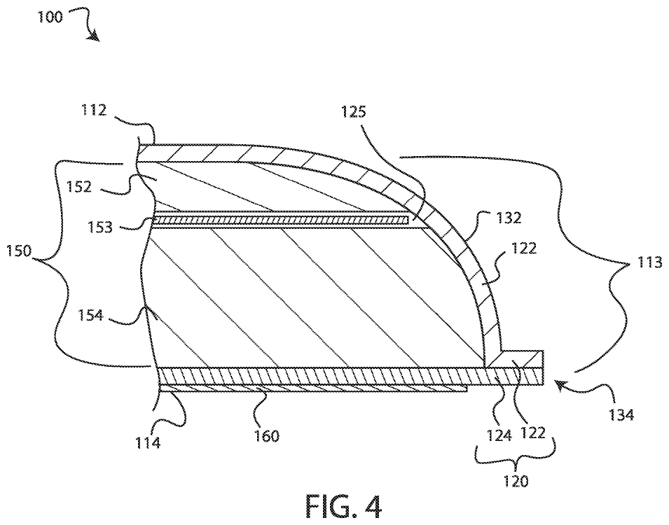

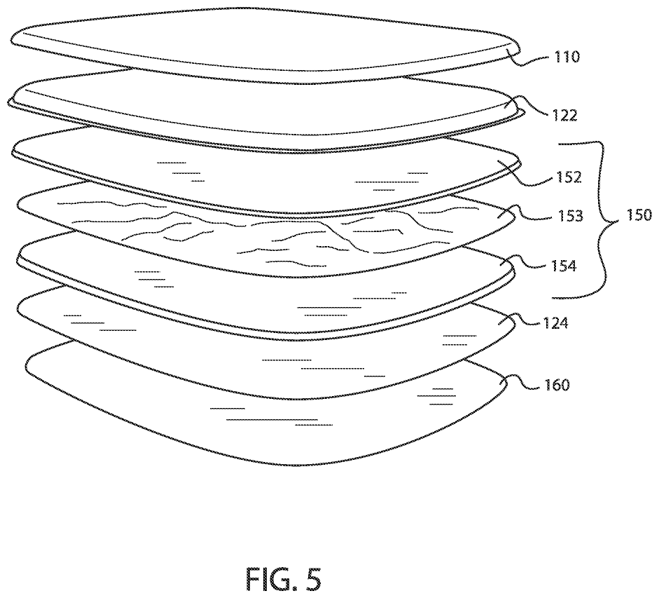

In various embodiments, and with reference to FIGS. 4 and 5, the crafting pad 100 is comprised of an enclosure portion 120 and a multi-layered composite portion 150. The enclosure portion 120 is generally referred to herein as the exterior cover of the crafting pad 100, and the enclosure portion 120 generally defines an enclosure pocket 125 (e.g., an internal volume) within which the multi-layered composite portion 150 is retained. One or more coatings, aesthetic layers, cosmetic layers, print layers, etc. may be coupled to the enclosure portion 120 of the crafting pad 100, such as upper cosmetic layer 110 and foot layer 160.

In various embodiments, the enclosure portion 120 comprises a first enclosure layer 122 and a second enclosure layer 124. The first enclosure layer 122 and the second enclosure layer 124 may be separate pieces of material that are coupled together to form and define the enclosure pocket 125. In various embodiments, upper surface 112 may be a surface of the first enclosure layer 122 and the lower surface 114 may be a surface of the lower surface 114 of the crafting pad 100.

In various embodiments, the sidewall section 113 of the crafting pad 100 is a continuation of one or both of the upper surface 112 and the lower surface 114. That is, upper surface 112, which may be a surface of the first enclosure layer 122, layer may extend across the top of the contained multi-layered composite portion 150 and may extend down and around the peripheral edges of the multi-layered composition portion 150 to be joined with the second enclosure layer 124. Said differently, the first enclosure layer 122 may curve downward from the substantially planar upper surface 112 of the crafting pad 100 to form the sidewall section 113, and may be joined (e.g., adhered, bonded, sewn, or otherwise attached) to the second enclosure layer 124.

The sidewall section 113 of the crafting pad 100, as shown well in FIG. 4, may have a flange 134 along its lower perimeter, and this flange 134 may be where the first enclosure layer 122 is coupled/joined to the second enclosure layer 124. In various embodiments, the flange 134 is an outwardly extending lip, with respective interior surfaces of the enclosure layers 122, 124 positioned in abutting engagement with each other to form the flange 134.

In various embodiments, and with continued reference to FIG. 4, the lower side of the flange 134 may be substantially planar with the macro lower surface 114 of the crafting pad 100. That is, in response to the crafting pad 100 being supported by a flat planar surface, such as a platen of a heat press and/or a tabletop, the flange 134 may extend in a direction that is substantially parallel to the lower surface 114 and substantially parallel to the flat planar surface of the tabletop/platen. In various embodiments, the flange 134 is the outward most edge of the crafting pad 100, and thus the largest, outward most footprint of the crafting pad 100 may be defined by the flange 134.

In various embodiments, and with specific reference to FIG. 4, the sidewall section 113 of the crafting pad 100 has an outwardly facing surface 132 that tapers and/or is curved. For example, the sidewall section 113 of the crafting pad 100 may have an outwardly facing surface 132 that transitions downward from the substantially planar upper surface 112 of the crafting pad 100 towards the lower surface 114 of the crafting pad 100. In various embodiments, the sidewall section 132 has a convex curvature (i.e., the outwardly facing surface 132 of the sidewall section 113 is convex), and this convex curvature may terminate at or adjacent to the flange 134. This convex curvature of the sidewall section 113 may be present along the entire circumference/periphery of the crafting pad 100 (i.e., the curved sidewall section 113 may extend circumferentially around the entire perimeter of the crafting pad 100).

In various embodiments, the multi-layered composite portion 150 is entirely retained within the enclosure pocket 125. The multi-layered composite portion 150 of the crafting pad 100 may comprise a first fill layer 152 and a heat-reflecting layer 153. The multi-layered composite portion 150 may further include a second fill layer 154. In various embodiments, the heat-reflecting layer 153 is disposed between the first fill layer 152 and the second fill layer 154. The fill layers 152, 154 may comprise a foam or textile fill material and the heat-reflecting layer 153 may comprise a metallic material configured to reflect heat back towards a workpiece engaged against the upper surface 112 of the crafting pad 100. For example, the first fill layer 152 may be a fibrous material, such as a felt material (e.g., a polyester felt material) or a batting material, the intermediate heat-reflecting layer 153 may be a metallic foil material, such as aluminum material, and the second fill layer 154 may be a foam material, such as a silicone foam material.

In various embodiments, the crafting pad 100 may include one or more surface layers, such as a cover layer 110 (FIG. 5) and/or a foot layer 160 (FIGS. 4 and 5). These surface layers may comprise a textile material, a rubber material, a plastic material, a silicone material, or the like. For example, the cover layer 110 may be attached to the first enclosure layer 122 and may thus form the upper surface 112 of the crafting pad 100. This cover layer 110 may be a woven textile material and may have a heat resistant coating, according to various embodiments.

In various embodiments, and with reference to FIGS. 4, 5, 8, the foot layer 160 may be attached to the lower enclosure layer and may thus form the lower surface 114 of the crafting pad 100. The foot layer 160 may be a silicone print material. The foot layer 160 may be a securement structure of the crafting pad 100, and thus may be configured to facilitate fictional engagement of the crafting pad 100 relative to a crafting machine (e.g., a platen of a heat press) and/or a tabletop surface against which it is engaged. Additional details pertaining to securement of the crafting pad relative to a heat press are described below with reference to FIGS. 7, 8, and 9.

In various embodiments, and with continued reference to FIGS. 4 and 5, exemplary materials and exemplary thickness of the various layers are provided below:

| | General | | Exemplary |
|---|---|---|---|
| Ref. # | Description | Exemplary Material | Thickness |
| 110 | Cover Layer | Textile material | 0.18 mm |
| | | shining woven 3% elastic | |
| | | heat resistant coating | |
| 122 | First Enclosure | poly non-woven felt | 1.0 mm |
| | Layer | | |
| 152 | First Fill Layer | Polyester Felt | 4.0 mm |
| | | | (compresses |
| | | | to 3.0 mm) |
| 153 | Heat-Reflecting | Aluminum foil | 0.2 mm |
| | Layer | | |
| 154 | Second Fill Layer | silicone foam | 6.0 mm |
| 124 | Second Enclosure | poly non-woven felt | 2.0 mm |
| | Layer | | |
| 160 | Foot Layer | Silicone Print | 0.5 mm |

In various embodiments, the exemplary materials and the exemplary thicknesses of the various layers in the table above are illustrative and are not intended to limit the scope of the disclosure. In various embodiments, during manufacturing of the crafting pad, the cover layer 110 and the first enclosure layer 122 may be compression formed together, and this may compress these two layers until they have a combined thickness of about 0.9 mm. Similarly, the foot layer 160 and the second enclosure layer 124 may be compressed together after, for example, a joining or printing process, which can compress the combined thickness of those two layers to about 1.6 mm. As used in this context (pertaining to thickness of the various materials), the term “about” means plus or minus 10% of the indicated value. In various embodiments, the total thickness of the crafting pad may be between about 5.0 mm and about 30.0 mm. In various embodiments, the total thickness of the crafting pad may be between about 10.0 mm and 20.0 mm. In various embodiments, the total thickness of the crafting pad may be between about 13.0 mm and about 15.0 mm, or about 13.9 mm. However, after the compressing forming and/or printing sub-processes, the resultant/practical thickness of the entire crafting pad 100 may be between about 11.2 mm and about 12.2 mm, or may be about 11.7 mm. In various embodiments, the foot layer 160, which also may be the securement structure of the crafting pad, may have a specific geometric pattern, as shown in FIG. 2.

In various embodiments, the second fill layer 154 has a greater thickness than the first fill layer 152. Said differently, the crafting pad 100 may have more (as measured by thickness) fill material below the heat-reflecting layer 153 than above the heat-reflecting layer 153. For example, the second fill layer 154 may have a thickness that is between 50% and 100% more than the thickness of the first fill layer 152. In various implementations, heat from a heat press may be transmitted through a workpiece engaged against the upper surface 112 of the crafting pad and through the first fill layer 152 before being reflected by the heat-reflecting layer 153 back through the first fill layer 152 and back to the workpiece. Thus, the first fill layer 152 may be configured to provide a degree of the aforementioned ‘cushioning’ while also enabling bi-directional heat transfer therethrough. Correspondingly, the second fill layer 154 disposed below the heat-reflecting layer 153 may be configured to further provide ‘cushioning’ but instead may have lower thermal conductivity than the first fill layer 152 (i.e., may be more thermally insulative), thus inhibiting the transfer of heat therethrough to thereby mitigate heat transfer through the entire crafting pad 100.

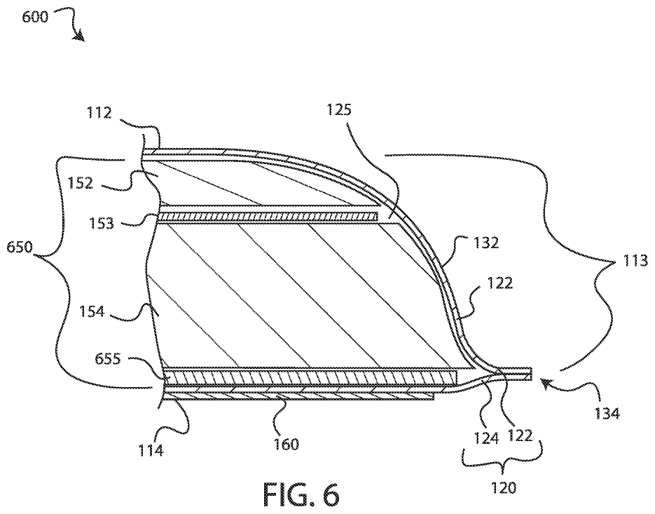

In various embodiments and with momentary reference to FIG. 6, the crafting pad 600 may also include a stiffening panel 655 disposed within the enclosure pocket 125 defined by the enclosure portion 120. The stiffening panel 655 may be a layer of the multi-layered composite portion 150 of the crafting pad 100. In various embodiments, the stiffening panel 655 is disposed between the second fill layer 154 and the second enclosure layer 124. The stiffening panel 655 may be configured to impart additional rigidity to the crafting pad 600, according to various embodiments.

In various embodiments, and with reference to FIG. 7, an exemplary heat press 170 is provided. The heat press 170 is a clamshell-type heat press, and is generally configured to press materials or objects, referred to herein as workpieces, between opposing platens and to apply heat. Some clamshell heat presses may include two opposing platens that are both heated. Alternatively, clamshell heat presses may include an upper heated platen and a lower un-heated platen. In various embodiments, a lower, unheated platen provides a flat, rigid surface to support workpieces thereon while an upper platen presses downward onto lower platen to transfer heat and pressure into the workpieces.

Heat press 170, in accordance with various embodiments and with continued reference to FIG. 7, includes an upper assembly 171 having a heat plate 172, a lower assembly 176 having a platen 177, and a hinge base 175. The upper assembly 171 may be pivotably coupled to the lower assembly 176 via the hinge base 175 such that the upper assembly 171 is configured to pivot and move relative to the lower assembly 176. The heat press 170 may be configured to heat and compress, between the heat plate 172 and the platen 177, a workpiece. For example, the heat press 170 may be utilized to compress, between the heat plate 172 and the platen 177, a heat-activated design implement against the workpiece to transfer a design of the heat-activated design implement to the workpiece. The heat may be provided by one or more heat elements (e.g., heating coils) integrated with, disposed within, disposed adjacent to, or otherwise coupled to the material that defines the heat plate 172.

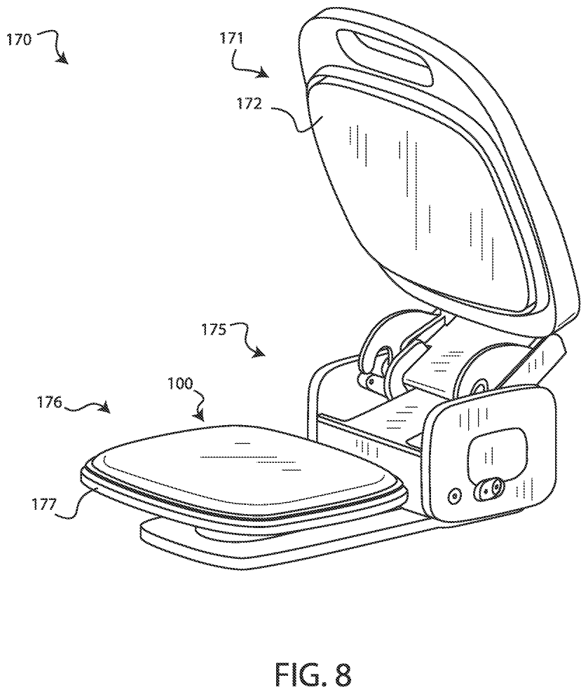

In various embodiments, and with reference to FIG. 8, a heat press 170 is shown with the crafting pad 100 positioned on the platen 177 of the lower assembly 176. As explained above, the crafting pad 100 may provide various benefits and may generally improve the ease, uniformity, and/or consistency of the heat transfer procedure. In various embodiments, the crafting pad 100 may include securement structure for temporarily and/or reversibly/detachably securing the crafting pad 100 to a lower platen of a heat. For example, the foot layer 160 may facilitate frictional engagement between the crafting pad and planar surface of the platen. That is, the securement structure of the crafting pad may include a high friction layer or coating on the lower surface of the pad to interface with the top surface of a platen. Such a high friction layer or coating may secure the pad to the platen, either on its own or in combination with other securement mechanisms described below, so that the pad is prevented or at least inhibited from slipping off or otherwise shifting relative to the platen during use.

Regarding securement of the crafting pad relative to the platen or tabletop upon which the crafting pad rests, and returning to reference FIGS. 4 and 6, the tapered and/or curved sidewall section 113 of the crafting pad 100 may also contribute to securement of the crafting pad 100. For example, during handling of the workpiece and/or the crafting pad in preparation for a heat press procedure, a user may inadvertently exert a lateral (e.g., sideways) force on the workpiece or the crafting pad, and this lateral force could potentially cause the workpiece, the crafting pad, and/or the heat plate of the heat press to become misaligned relative to each other. However, with the curved sidewall section 113 of the crafting pad (i.e., with the outwardly facing surface 132 of the sidewall section 113 having a convex curvature), forces exerted on the crafting pad, such as lateral forces exerted at or along the upper surface 112 of the crafting pad 100, are transferred and/or redirected along the convex curvature toward the flange 134 and/or towards the platen or tabletop upon which the lower surface 114 of the crafting pad is engaged. Said differently, the convex curvature of the sidewall section 113 of the crafting pad 100 facilitates securement of the crafting pad 100 by redirecting lateral forces to be downward forces, thereby improving the frictional engagement between the lower surface 114 of the crafting pad 100 and the platen or tabletop.

In various embodiments, and with continued reference to FIG. 4, the convex curvature of the sidewall section 113 of the crafting pad 100 may be a result of a corresponding/complementary curvature of one or more layers of the multi-layered composite portion 150 housed within the enclosure pocket 125. For example, one (or both) of the fill layers 152, 154 of the multi-layered composite portion 150 may have a peripheral edge (e.g., a perimeter and/or a circumferential border) that is convexly curved so as to correspondingly impart the convex curvature to the sidewall section 113. That is, the outwardly facing sidewall surface of at least one or more of the fill layers 152, 154 of the multi-layered composite portion 150 may be convex, and the first enclosure layer 122 extending across and/or around this convex surface may adopt a similar/corresponding convex geometry. In various embodiments, both the first fill layer 152 and the second fill layer 154 are convexly curved so that both layers contribute to the convex curvature of the sidewall section 113.

In various embodiments, and with reference to FIG. 8, the crafting pad 900 may include a skirt portion 935 extending from the sidewall section 913 and/or the enclosure portion 920 (or rather, the enclosure portion 920 may simply include the skirt portion 935). The skirt portion 935 may be generally configured to reversibly extend around and at least partially envelope a border edge of a platen 177 of a heat press to facilitate retention of the crafting pad 900 against the platen 177. The skirt portion 935, which may be referred to herein as a securement mechanism, may be a flexible and/or elastic material that can be pulled down and around the platen. In various embodiments, the skirt portion 935 may include a first portion forming a generally vertically disposed outer sidewall and a second portion extending from the first portion. The second portion may be disposed generally horizontal along a lower surface of the crafting pad. In various embodiments, the first and second portions of the securement skirt may be disposed at angles other than vertical and horizontal, respectively, relative to the body of the crafting pad. In any case, first and second portions may be generally disposed at an angle relative to one another such that second portion extends at least partially underneath the crafting pad (and so that it may extend underneath the lower platen of the heat press).

However, as noted above, the securement skirt, which may include an elastic band and may be flexible such that one or more sections of the securement skirt can be flexed or otherwise manipulated away from the pad. For example, at least one or more sections of the lower portion of the securement skirt may be pulled away from the pad. Said differently, the securement skirt, or at least a portion thereof, may be made from a flexible material such that it can be flexed, bent, or otherwise manipulated.

In various embodiments, the lower lip of the lower portion of the securement skirt may be stretched around an outer perimeter edge of platen to removably secure the pad to the platen. In various embodiments, the securement skirt may have elastic properties (e.g., an elastic band), and thus at least the second portion (the lower portion) of the securement skirt may have a smaller circumference than the circumference of the platen. The elastic properties of the securement skirt allows the securement skirt to be stretched to a greater circumference than that of platen. Once the elastic band is stretch over the outer perimeter edge/circumference of platen, the elastic band will elastically return around and underneath the platen, thus removably securing assembly 10 thereto. Accordingly, the elastic band of the securement skirt may bias the securement skirt toward a collapsed/compressed shape.

In various embodiments, the elastic band of the securement skirt may be formed of one or more of the following elastic materials: silicone, rubber, TPU, TPE, elastomeric materials, latex, neoprene; and the like. Similar or other materials may be used in isolation or in combination with one another to form elastic band having a modulus of elasticity and other mechanical material properties similar to those materials listed.

In various embodiments, the crafting pad may be used with workpieces of various materials. The body of the workpiece may be a fabric material, a paper material or the like. Arrangements of a fabric material may be used for the purpose of sewing or quilting, such as, for example, quilt blocks. The fabric material includes one or more of, for example, cotton, silk, linen, wools, cashmere, leather, ramie, hemp, jute, rayon/viscose, acetate, lycocell, azlon, polyester, nylon, acrylic, spandex, latex, polypropylene, polyethylene, carbon, vinyl. Fabric blends consisting of one or more parts of cotton, silk, linen, wools, cashmere, leather, ramie, hemp, jute, rayon/viscose, acetate, lycocell, azlon, polyester, nylon, acrylic, spandex, latex, polypropylene, polyethylene, carbon and vinyl. Furthermore, the fabric may be in the form of, for example, aertex, aida, baize, batiste, bird's eye knit, bombaize, brocade, buckram, cable knit, calico, cambric, charmeuse, chenille, corduroy, caement, cheese cloth, cheviot, chiffon, chino, chintz, crepe, crewel, damask, denim, dimity, double knit, drill, duck or canvas, felt, fiberglass, filter, flannel, flat or jersey knit, fleece knit, foulard, fustian, gabardine, gauze, georgette, gingham, grey or greige, industrial, intarsia knit, interlock stick knit, jacquard knit, kashmir silk, khadi, khaki, lame, laminated, lawn, leno, linsey-woolsey, madras, madras muslin net, mousseline, muslin, narrow laces or tapes, organdy, organza, oxford, percale, plain, pointelle, poplin, purl knit, quilted, raschel knit, reflective, rib stitch knit, satin or sateen, shantung, sheeting, silver knit, taffeta, stretch, tartan, terry knitted, terry cloth, ticking, tissue, tricot knit, velour knitted, velvet, voile, warp knitted and whipcord. In some instances, the body of material 52 may be shaped in any desirable configuration (e.g., wearable apparel, accessories, household goods, decorative goods and the like). Wearable apparel may include but is not limited to, for example, a dress, a raiment, or a vesture such as, for example: a shirt, a sweater, a hat, pants, socks or the like. Accessories may include but is not limited to, for example, a bag, a tote bag, totes, towels or the like. Household goods may include but is not limited to, for example, towels, mats, curtains, blankets, coverings, tablecloths, pillows or the like. Decorative goods may include but is not limited to, for example, canvases, holiday ornamentation, banners, pennants, and the like.

The material of the workpiece may contain moisture, or the moisture may also be found in surrounding atmosphere. As such, the body of the workpiece may, for example, absorb or wick the moisture from the surrounding atmosphere. The multilayered body of the crafting pad may be utilized to improve heat delivery to the workpiece, and to enable moisture to be removed/drawn away from the target area of the workpiece during a heat press procedure (e.g., during a heat-activated design transfer). In various embodiments, the heat-activated design implement may include a heat-activated adhesive.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure.

Reference throughout this specification to features, advantages, or similar language does not imply that all the features and advantages that may be realized with the present disclosure should be or are in any single embodiment of the invention. Rather, language referring to the features and advantages is understood to mean that a specific feature, advantage, or characteristic described in connection with an embodiment is included in at least one embodiment of the subject matter disclosed herein. Thus, discussion of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize that the subject matter of the present application may be practiced without one or more of the specific features or advantages of a particular embodiment. In other instances, additional features and advantages may be recognized in certain embodiments that may not be present in all embodiments of the disclosure. Further, in some instances, well-known structures, materials, or operations are not shown or described in detail to avoid obscuring aspects of the subject matter of the present disclosure. No claim element is intended to invoke 35 U.S.C. 112 (f) unless the element is expressly recited using the phrase “means for.”

As used herein, the terms “including,” “comprising,” “having,” and variations thereof mean “including but not limited to” unless expressly specified otherwise. Accordingly, the terms “including,” “comprising,” “having,” and variations thereof are intended to cover a non-exclusive inclusion, such that a process, method, article, or apparatus that comprises a list of elements does not include only those elements but may include other elements not expressly listed or inherent to such process, method, article, or apparatus. An enumerated listing of items does not imply that any or all of the items are mutually exclusive and/or mutually inclusive, unless expressly specified otherwise.

Further, in the detailed description herein, references to “one embodiment,” “an embodiment,” “some embodiments,” “various embodiments,” “one example,” “an example,” “some examples,” “various examples,” “one implementation,” “an implementation,” “some implementations,” “various implementations,” “one aspect,” “an aspect,” “some aspects,” “various aspects,” etc., indicate that the embodiment, example, implementation, and/or aspect described may include a particular feature, structure, or characteristic, but every embodiment, example, implementation, and/or aspect may not necessarily include the particular feature, structure, or characteristic. Moreover, such phrases are not necessarily referring to the same embodiment, example, implementation, or aspect. Thus, when a particular feature, structure, or characteristic is described in connection with an embodiment, example, implementation, and/or aspect, it is submitted that it is within the knowledge of one skilled in the art to affect such feature, structure, or characteristic in connection with other embodiments, examples, implementations, and/or aspects, whether or not explicitly described. Absent an express correlation to indicate otherwise, features, structure, components, characteristics, and/or functionality may be associated with one or more embodiments, examples, implementations, and/or aspects of the present disclosure. After reading the description, it will be apparent to one skilled in the relevant art how to implement the disclosure in alternative configurations.

The scope of the disclosure is to be limited by nothing other than the appended claims, in which reference to an element in the singular is not intended to mean “one and only one” unless explicitly so stated, but rather “one or more.” It is to be understood that unless specifically stated otherwise, references to “a,” “an,” and/or “the” may include one or more than one and that reference to an item in the singular may also include the item in the plural. Further, the term “plurality” can be defined as “at least two.” As used herein, the phrase “at least one of”, when used with a list of items, means different combinations of one or more of the listed items may be used and only one of the items in the list may be needed. The item may be a particular object, thing, or category. Moreover, where a phrase similar to “at least one of A, B, and C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A, B, and C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

All ranges and ratio limits disclosed herein may be combined. Numbers, percentages, ratios, or other values stated herein are intended to include that value, and also other values that are “about” or “approximately” the stated value, as would be appreciated by one of ordinary skill in the art encompassed by embodiments of the present disclosure, unless otherwise defined herein. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

Different cross-hatching may be used throughout the figures to denote different parts but not necessarily to denote the same or different materials. Surface shading lines may be used throughout the figures to denote different parts or areas but not necessarily to denote the same or different materials. In some cases, reference coordinates may be specific to each figure. Furthermore, the connecting lines shown in the various figures contained herein are intended to represent exemplary functional relationships and/or physical couplings between the various elements. It should be noted that many alternative or additional functional relationships or physical connections may be present in a practical system.

Any reference to attached, fixed, connected or the like may include permanent, removable, temporary, partial, full and/or any other possible attachment option. Additionally, any reference to without contact (or similar phrases) may also include reduced contact or minimal contact. In the above description, certain terms may be used such as “up,” “down,” “upper,” “lower,” “horizontal,” “vertical,” “left,” “right,” and the like. These terms are used, where applicable, to provide some clarity of description when dealing with relative relationships. But these terms are not intended to imply absolute relationships, positions, and/or orientations. For example, with respect to an object, an “upper” surface can become a “lower” surface simply by turning the object over. Nevertheless, it is still the same object.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

The subject matter of the present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. A crafting pad comprising:
an enclosure portion defining an enclosure pocket; and
a multi-layered composite portion retained in the enclosure pocket;
wherein the crafting pad is configured to facilitate heat transfer from a heat press to a workpiece operably engaged against the crafting pad.

2. The crafting pad of claim 1, wherein:
the crafting pad comprises an upper surface, a lower surface opposite the upper surface, and a sidewall section that defines a perimeter of the crafting pad; and
an outwardly facing surface of at least a portion of the sidewall section has convex curvature, as defined along a direction extending from the upper surface toward the lower surface.

3. The crafting pad of claim 2, wherein the sidewall section having the convex curvature extends entirely and circumferentially around the perimeter of the crafting pad.

4. The crafting pad of claim 2, wherein the convex curvature extends from the upper surface to a flange of the sidewall section of the crafting pad.

5. The crafting pad of claim 4, wherein the flange is an outwardly extending lip.

6. The crafting pad of claim 5, wherein:
the enclosure portion comprises a first enclosure layer, said upper surface being a surface of the first enclosure layer;
the enclosure portion comprises a second enclosure layer, said lower surface being a surface of the second enclosure layer; and
the first enclosure layer is coupled to the second enclosure layer at the flange.

7. The crafting pad of claim 6, wherein the outwardly facing surface of the sidewall section is a surface of the first enclosure layer, such that the first enclosure layer forms the upper surface and extends to form the outwardly facing surface of the sidewall section of the crafting pad.

8. The crafting pad of claim 7, wherein in response to the crafting pad being supported by a flat planar surface, such as a platen of a heat press and/or a tabletop, the flange extends in a direction that is substantially parallel to the lower surface and substantially parallel to the flat planar surface.

9. The crafting pad of claim 5, wherein the flange forms the outward most footprint of the crafting pad.

10. The crafting pad of claim 9, further comprising a foot layer coupled to the lower surface, the foot layer configured to facilitate frictional engagement with at least one of a platen of a heat press and a tabletop.

11. The crafting pad of claim 10, wherein the foot layer comprises at least one of a silicone material and a rubber material.

12. The crafting pad of claim 1, further comprising a skirt portion extending from the enclosure portion, the skirt portion being configured to reversibly extend around and at least partially envelope a border edge of a platen of a heat press to facilitate retention of the crafting pad against the platen.

13. The crafting pad of claim 1, wherein the multi-layered composite portion comprises:
at least one fill layer; and
a heat-reflective layer.

14. The crafting pad of claim 13, wherein the multi-layered composite portion is entirely retained within the enclosure pocket.

15. The crafting pad of claim 13, wherein:
the at least one fill layer comprises a first fill layer and a second fill layer; and
the heat-reflective layer is disposed between the first fill layer and the second fill layer.

16. The crafting pad of claim 15, wherein:
the first fill layer comprises a fibrous material;
the heat-reflective layer comprises a metallic foil material; and
the second fill layer comprises a foam material.

17. The crafting pad of claim 15, wherein:
the first fill layer comprises at least one of a polyester felt material and a polyester batting material;
the heat-reflective layer comprises aluminum; and
the second fill layer comprises a fibrous material.

18. The crafting pad of claim 1, further comprising a stiffening panel disposed within the enclosure pocket, the stiffening panel configured to impart additional rigidity to the crafting pad.

19. A crafting pad comprising:
an enclosure portion defining an enclosure pocket, the enclosure portion also defining an upper surface of the crafting pad, a lower surface of the crafting pad opposite the upper surface, and a sidewall section of the crafting pad that defines a perimeter of the crafting pad; and
a multi-layered composite portion retained in the enclosure pocket, the multi-layered composite portion comprising a first fill layer and a heat-reflective layer;
wherein:
an outwardly facing surface of a sidewall of at least the first fill layer of the multi-layered composite is convexly curved so as to correspondingly impart a convex curvature to the sidewall section of the enclosure portion; and
the crafting pad is configured to facilitate heat transfer from a heat press to a workpiece operably engaged against the crafting pad.

20. The crafting pad of claim 19, wherein the multi-layered composite further comprises a second fill layer, wherein an outwardly facing surface of a sidewall of the second fill layer is also convexly curved so as to also contribute to the convex curvature of the sidewall section.
